(19) United States
(12) Patent Application Publication
(10) Pub. No.: US 2021/0214815 A1
(43) Pub. Date: Jul. 15, 2021

(54) METHOD OF HARDENING MANGANESE STEEL USING ULTRASONIC IMPACT TREATMENT

(71) Applicant: Progress Rail Services Corporation, Albertville, AL (US)

(72) Inventors: Michael V. McCafferty, Pekin, IL (US); Samuel Abston, II, Chelsea, AL (US)

(73) Assignee: Progress Rail Services Corporation, Albertville, AL (US)

(21) Appl. No.: 16/738,816

(22) Filed: Jan. 9, 2020

(51) Int. Cl. C21D 7/04; F16C 33/14; B23P 9/04

(52) U.S. Cl. CPC C21D 7/04; C22C 38/04; B23P 9/04; F16C 33/14

(57) ABSTRACT

In accordance with one aspect of the present disclosure a method of hardening an article of manganese steel is shown. The method includes applying an ultrasonic impact treatment (UIT) on a surface of the article of manganese steel, the ultrasonic impact treatment corresponding to operational parameters, the operational parameters may include an operating ultrasonic frequency, mechanical energy, treatment travel speed, applied force, pattern, or coverage percentage, and each of the operational parameters are independently controllable.

### TECHNICAL FIELD

The present disclosure generally relates to alloy steel, and more particularly, to methods of hardening manganese steel.

### BACKGROUND

Manganese steel, also known as Hadfield steel, is an alloy steel that may contain 11-15% manganese. When it is produced, it usually has a hardness ranging from 180 to 230 Brinell. Manganese steel may be work-hardened by conventional means to a hardness sometimes in excess of 550 Brinell, and beyond, making it a very hard and tough material. Further, this alloy steel can work-harden under impact applied during working conditions. However, during the work hardening phase, a workpiece constructed of manganese steel is susceptible to wear and may lose up to 30% or more of its material.

In an attempt to alleviate loss of material and limit the initial wear during the work hardening, workpieces constructed of manganese steel are often pre-hardened using an explosion hardening stage. This hardening process may raise the Brinell hardness by 70-90 points prior to work hardening, but the increased strength is often on concentrated at a surface layer of the workpiece having a shallow depth and is inconsistent in coverage.

Korean Patent Publication No. 10-1424862, entitled Steel Material and a Manufacturing Method Thereof, provides for producing a steel material and treating a surface of the steel material with an ultrasonic impact treatment. The ultrasonic impact treatment includes repeatedly impinging a plurality of balls driven by ultrasonic waves on the surface and can be adjusted to collide 20,000-40,000 times per minute.

However, there is still a need for an effective way to increase the Brinell hardness and the depth of hardness in manganese steel.

### SUMMARY

In accordance with one aspect of the present disclosure, a method of hardening an article of manganese steel is disclosed. The method includes applying an ultrasonic impact treatment (UIT) on a surface of the article of manganese steel, the ultrasonic impact treatment corresponding to operational parameters, the operational parameters may include an operating ultrasonic frequency, mechanical energy, treatment travel speed, applied force, pattern, or coverage percentage, and each of the operational parameters are independently controllable.

In a further aspect a method of fabricating a workpiece is disclosed. The method included providing the workpiece manufactured of manganese steel and selecting the operational parameters of an ultrasonic impact device to achieve a desired physical characteristic of a surface layer of the workpiece. The operational parameters may include an operating ultrasonic frequency, mechanical energy, travel speed, applied force, patterns, or coverage percentage, and each of the operational parameters are independently controllable. The method further includes using the ultrasonic impact device to apply an ultrasonic impact treatment to the surface of the workpiece, the ultrasonic impact treatment corresponding to the selected operational parameters.

In yet another aspect of the present disclosure, a method of pre-hardening a workpiece is disclosed. The method may include providing a workpiece manufactured of manganese steel comprised of manganese steel, and an ultrasonic impact device. The ultrasonic impact device may have a transducer to produce ultrasonic waves and an indenter capable of transferring the ultrasonic waves to the workpiece. The method further including selecting operational parameters of an ultrasonic impact device to achieve a desired physical characteristic of a surface layer of the workpiece, the operational parameters include at least one of an operating ultrasonic frequency, mechanical energy, travel speed, applied force, patterns, coverage percentage, indenter arrangement, indenter diameter, indenter style, and indenter geometry, and each of the operational parameters are independently controllable. Additionally, the ultrasonic impact device may be used to apply an ultrasonic impact treatment to the surface of the workpiece, the ultrasonic impact treatment corresponding to the selected parameters.

These and other aspects and features of the present disclosure will be more readily understood when read in conjunction with the accompanying drawings.

### BRIEF DESCRIPTION OF THE DRAWINGS

FIG. 1 is a perspective view of a manganese steel bushing being hardened by an ultrasonic impact device, in accordance with aspects of the present disclosure.

FIG. 2 is a perspective view of the manganese steel bushing of FIG. 1 that has been partially hardened.

FIG. 3 is a side view of an ultrasonic impact device, in accordance with aspects of the present disclosure.

FIG. 4 is a flowchart depicting a sample sequence of steps which may be practiced according to a method of the present disclosure.

### DETAILED DESCRIPTION

The following detailed description is directed to technologies for hardening manganese steel. Manganese steel, also called Hadfield steel or mangalloy, is a steel alloy that traditionally contains around 11-15% manganese. Manganese steel has a high impact strength and resistance after it is work-hardened. Due to these self-hardening properties, manganese steel is often used in mining, cement mixers, rock crushers, crawler treads for tractors, and other high impact environments. During this work hardening process, 30% or more of a workpiece constructed of manganese steel may be lost due to wear. In some implementations of the present disclosure, various workpieces constructed of manganese steel and methods of pre-hardening the workpieces are used to prevent wear and increase the life span of the workpiece.

As described herein, ultrasonic impact treatment methodologies of the present disclosure can be applied to extend the useful life of a manganese steel workpiece by inducing compressive stress layers along any desired surface of the workpiece using an ultrasonic impact device. Through use of the disclosed methods, the useful life of the workpiece may be improved, such as increasing the Brinell hardness number, and depth of hardness, of a surface layer of the workpiece. Exemplary methodologies achieve the foregoing changes in mechanical properties by introducing ultrasound energy into the surface of the workpiece through a surface impulse contact, also known as ultrasonic impact treatment. The ultrasonic impact device introduces deformation on the surface layer which, in turn, induces a compressive residual stress. Since the contact probe can be customized to a desired shape, the ultrasonic impact treatment can be applied to any desired surface of the workpiece. As the workpiece is being used, the hardened surface layer prevents loss of the workpiece through wear and aides in hardening the subsurface layers.

References are made to the accompanying figures that form a part hereof, and which are shown by way of illustration, specific embodiments, or examples. Like numerals represent like elements through the several figures.

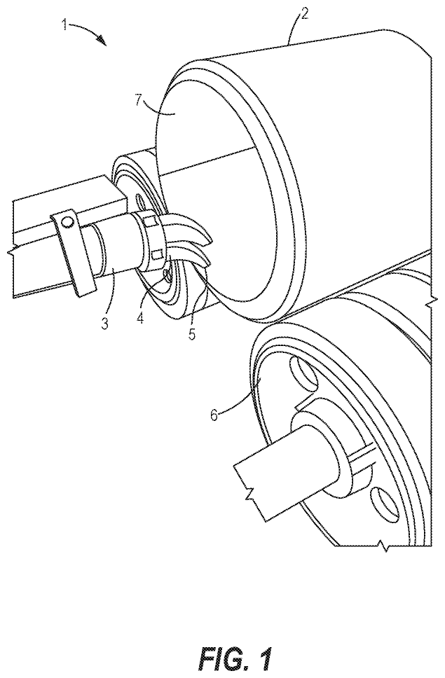

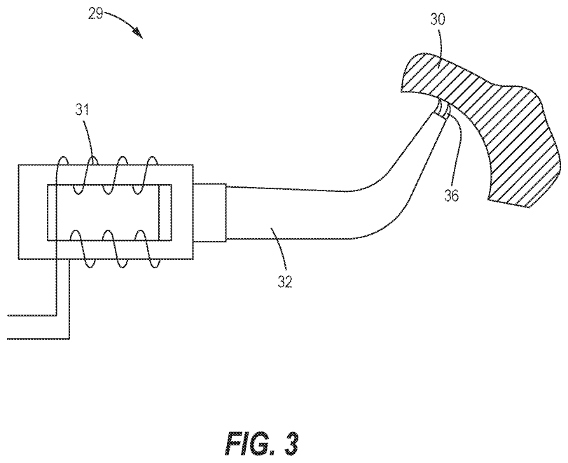

Referring now to the figures, and with specific reference to FIG. 1, a manganese steel hardening system 1 is shown for hardening manganese steel. In this embodiment, workpiece 2 constructed of manganese steel is shown. The workpiece 2 is shown as a cylindrical shaped bushing, but in some examples, an article of manganese steel may be used. To harden the workpiece 2, the ultrasonic impact device 3 having an inducer (shown in FIG. 3) and an indenter 5 can be used to apply an ultrasonic impact treatment (UIT) to a surface 7 of the workpiece 2. The FIG. 1 example shows two indenters 5, but a single indenter 5, or multiple, indenters 5 may be used depending on the selected operational parameters discussed below.

Further shown are rotating devices 6 capable of rotating the workpiece 6 during the application of the UIT. Although in the exemplary embodiment a workpiece 2 having a cylindrical shape is shown, since the UIT can be applied to any surface of the workpiece 2, the workpiece may be any shape. Further, although the FIG. 1 embodiment shows the workpiece 2 mechanically being spun and the ultrasonic impact device 3 under machine control, the UIT process may be applied by a variety of methods including manually, semi-automatically, CNC machine tools, robotically, or fully automatically and in both manufacturing and field environments. If applied manually, the ultrasonic impact device may be controlled by hand.

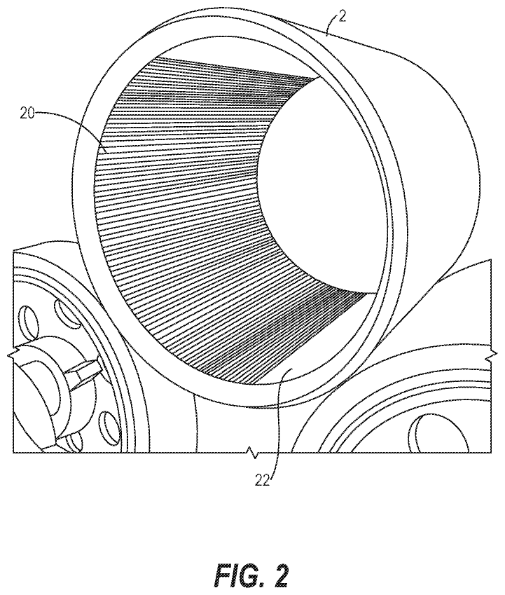

As best shown in FIG. 2, the UIT transforms electrical energy at ultrasonic frequencies and converts it into mechanical energy. The mechanical energy is focused at the surface 22 of the workpiece 2 to produce the hardened surface layer 20. In one embodiment, the UIT process is a peening process driven by ultrasonic energy produced in the ultrasonic impact device 3, and takes electrical energy at ultrasonic frequencies and converts it into mechanical energy. The mechanical energy is focused at the surface 22 of the workpiece 2 to plastically deform the surface of the manganese steel, and alter its grain structure, by imparting residual compressive stress, in turn, cold working the surface 22 and increasing the hardness and the depth of hardness to form the hardened surface layer 20.

The UIT process of hardening the workpiece 2 manufactured of manganese steel is achieved by combining and controlling a combination of UIT parameters. By applying the UIT to the surface of manganese steel, the life of the manganese steel is increased due to decreased ware of the material. In certain embodiments, the operational and controllable parameters of the UIT process include ultrasonic frequency, mechanical energy, travel speed, applied force, patterns, coverage percentage, indenter arrangement, indenter diameter, indenter style, and indenter geometry. All UIT parameters are controllable and can be changed to provide a predictable and desired result. In one embodiment, the desired result is a desire physical characteristic of the workpiece, and this may include a desired increases in Brinell hardness, depth of hardness, or change or control of the surface roughness profile.

The UIT process, in one non-limiting embodiment, is a form of cold working in which the surface 22 of the workpiece 2 is plastically deformed resulting in densification and modification of the manganese steel micro structure to form the hardened surface layer 20. The act of densification of the micro structure increases the surface hardness and depth of hardness in the manganese steel. The depth of hardness may be determined by process parameter control with the ability to additionally achieve predictable surface roughness. In an exemplary embodiment, the surface roughness of the workpiece 2 may be produced in a range of surface profiles between 32 and 125 Ra. The surface roughness of the manganese steel bushing creates an additional wear surface that assists in the life extension of the manganese steel workpiece 2.

An exemplary embodiment of an ultrasonic device 29 for applying the UIT to a workpiece 30 is shown in FIG. 3. In this example, the transducer 31 is coupled to a suitable power oscillator source (not shown). The output vibrations may be transmitted by special instrumentation such as a waveglide 32 for conveying the impulse energy without significant losses to the indenter 36 and then to the curved surfaces of the workpiece 30, or hard to reach regions of the workpiece

### INDUSTRIAL APPLICABILITY

In general, the foregoing disclosure finds utility in various applications, such as, in metallurgy, and construction of workpieces to be used in high impact environments. In particular, the disclosed manganese steel hardening method may be used on a variety of manganese steel workpieces, such as, a bushing and the like. By applying the disclosed hardening method to a workpiece, optimum hardening, depth of hardening, and surface roughness profile may be achieved.

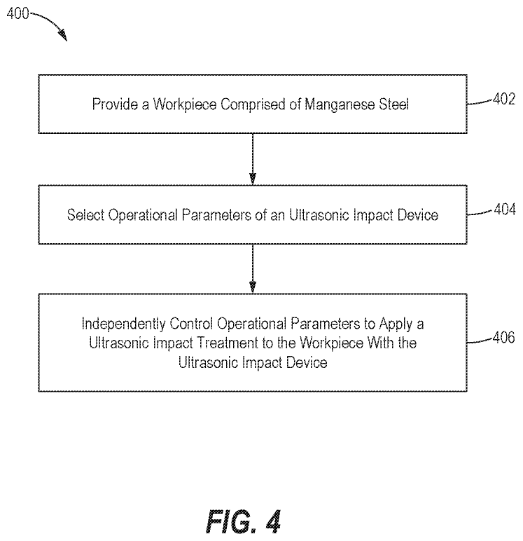

Turning now to FIG. 4, with continued references to FIGS. 1-3, a flowchart illustrating an example process 400 for hardening a surface layer 20 of a workpiece 2 constructed of manganese steel. At block 402, a workpiece 2 comprised of manganese steel is provided. In certain embodiments, the workpiece is first secured, for example, using a fixture. Such use of a fixture is particularly suitable in embodiments that employ precise robotic modes of application, whereby the ultrasonic impact device is operated by robotic mechanisms. Additionally, an ultrasonic impact device 3 is provided and may be operated by hand or robotically with use of machinery.

At block 404, the operational parameters of the ultrasonic impact device 3 are selected and configured to correspond to the operational parameters of a desired physical characteristic of the workpiece. This desired characteristic may be a desired Brinell hardness, depth of hardness, or surface roughness. The operation parameters may include, for example, device settings and/or physical characteristics of the ultrasonic impact device 3. Physical characteristics of the ultrasonic impact device may include, for example, the indenter 36 arrangement (a single indenter or multiple), the diameter of the indenter (ranging from 3.0 millimeters (mm) to 20 mm), the indenter style (rod and ball or other), and the indenter geometry (including 1:1 radius, 1:2 to about 6 radius (domed), flat, or custom shape. Similarly, the operational parameters, such as operating frequency and mechanical energy range (oscillation amplitude), may be controlled based on the desired physical characteristic. The operational parameters may further include, for example, an ultrasonic frequency range between 18 to 36 kilohertz, a mechanical energy range of about 20 to 40 microns, an applied force range of about 15 to 40 pounds, a treatment travel speed in the range of 1.00 mm a second to about 60 mm a second. Additionally, the operational parameter of applied pattern may include the following patterns: random, linear, orbital, grid, and custom program. The coverage percentage is also an operational parameter and may be programmable to 50% to about 500% (infinite based application requirement).

In one example, the configuration of the ultrasonic impact device 3 is achieved using one or more user-selectable settings of the ultrasonic impact device, which can be adjusted or otherwise set according to the desired or expected operational parameters necessary.

At block 406, the ultrasonic impact device 3 is used to apply the UIT and induce residual compressive stress layers along one or more desired surfaces of the workpiece 2, thereby increasing the hardness and depth of hardness of a surface layer 20 of the workpiece. Independent control of all selected operational parameters is used to achieve the desired physical characteristic on the workpiece 2.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term was expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

What is claimed is:

1. A method of hardening an article of manganese steel which comprises applying an ultrasonic impact treatment on a surface of the article, the ultrasonic impact treatment corresponding to operational parameters, the operational parameters comprise at least one of an operating ultrasonic frequency, mechanical energy, treatment travel speed, applied force, pattern, or coverage percentage, and each of the operational parameters being independently controllable.

2. The method of claim 1, in which the ultrasonic impact treatment is applied with an ultrasonic impact device, and the operational parameters further comprise at least one of an indenter arrangement, indenter diameter, indenter style, or indenter geometry.

3. The method of claim 2, in which the ultrasonic frequency has a range of 19 to 36 kilohertz.

4. The method of claim 2, in which the applied pattern is selected from a group consisting of linear, orbital, grid, or a custom program.

5. The method of claim 2, in which when the ultrasonic impact process is applied to the surface, the surface is plastically deformed resulting in densification of the manganese steel, the densification increasing hardness and depth of a surface layer of the manganese steel.

6. A method of fabricating a workpiece, the method comprising:
providing the workpiece, the workpiece comprised of manganese steel;
selecting operational parameters of an ultrasonic impact device to achieve a desired physical characteristic of a surface layer of the workpiece, the operational parameters comprise at least one of an operating ultrasonic frequency, mechanical energy, travel speed, applied force, patterns, or coverage percentage, and each of the operational parameters are independently controllable;
using the ultrasonic impact device to apply an ultrasonic impact treatment to a surface of the workpiece, the ultrasonic impact treatment corresponding to the selected operational parameters.

7. The method of claim 6 in which the workpiece is a bushing, and the ultrasonic impact treatment is applied to an interior surface of the bushing.

8. The method of claim 6, the ultrasonic impact treatment is configured to increase the Brinell hardness of the surface layer of the workpiece defined by a depth of hardness.

9. The method of claim 8, in which the depth of hardness is determined by the selected operational parameters.

10. The method of claim 9, in which the ultrasonic impact treatment increases the Brinell hardness and depth of hardness by plastically deforming the surface layer resulting in densification of the manganese steel.

11. The method of claim 10, in which the ultrasonic impact device further comprises an indenter, and the operational parameters further comprise at least one of an indenter arrangement, indenter diameter, indenter style, or indenter geometry.

12. The method of claim 11, in which the indenter is driven by ultrasonic waves to repeatedly impact the surface causing the indenter to acoustically couple with the workpiece.

13. The method of claim 6, in which the physical characteristic is a desired roughness of the surface.

14. The method of claim 13, in which the surface roughness can be produced in a range between 32 and 125 Ra.

15. The method of claim 5, in which the ultrasonic impact treatment is applied using CNC machine tools by rotating the workpiece or the ultrasonic impact device.

16. A method of pre-hardening a workpiece, the method comprising:
providing the workpiece, the workpiece comprised of manganese steel;
providing an ultrasonic impact device, the ultrasonic impact device including a transducer to produce ultrasonic waves and a indenter configured to transfer the ultrasonic waves to the workpiece;
selecting operational parameters of an ultrasonic impact device to achieve a desired physical characteristic of a surface layer of the workpiece, the operational parameters comprise at least one of an operating ultrasonic frequency, mechanical energy, travel speed, applied force, patterns, coverage percentage, indenter arrangement, indenter diameter, indenter style, and indenter geometry, and each of the operational parameters are independently controllable; and
using the ultrasonic impact device to apply an ultrasonic impact treatment to the surface of the workpiece, the ultrasonic impact treatment corresponding to the selected parameters.

17. The method of claim 16, in which the ultrasonic impact device converts electrical energy at ultrasonic frequencies and converts it into mechanical energy.

18. The method of claim 17 in which the ultrasonic frequencies and mechanical energy are determined by the selected operation parameters.

19. The method of claim 18, in which the mechanical energy is focused at the surface of the workpiece imparting residual compressive stress.

20. The method of claim 19, in which the ultrasonic impact treatment is configured to harden the manganese steel and reduce wear of a surface layer.
